(19) United States
(12) Patent Application Publication
(10) Pub. No.: US 2002/0081408 A1
(43) Pub. Date: Jun. 27, 2002

(54) CONTAINER FOR FREEZE-DRYING AND STORING MEDICAL PRODUCTS

(76) Inventors: MICHAEL SPALLER, (US); JOCHEN HEINZ, (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 09/288,227

(22) Filed: Apr. 8, 1999

(30) Foreign Application Priority Data
Apr. 9, 1998 (DE) 198.15.993.3

(51) Int. Cl. B32B 1/02

(52) U.S. Cl. 428/35.7

(57) ABSTRACT

A container for freeze-drying and storing medical products ensures homogeneous freeze-drying and secure storage of freeze-dried substances and are produced from translucent or transparent plastic with very uniform wall thicknesses and geometry. To ensure homogeneous freeze-drying, each of the containers have flat side areas that make planar contact with the side areas of respectively adjacent container bodies.

### FIELD OF THE INVENTION

This invention relates to a novel container for freeze-drying and storing medical products. Such containers have a body, a neck, and a head part, where the container can be sealed by inserting or pushing in a suitable closure after the medical products that are in the container are freeze-dried.

### BACKGROUND OF THE INVENTION

According to present prior art, the medical material that is to be dried by means of freeze-drying is decanted into vials that are typically made of glass tubing corresponding to DIN ISO 8362, Part 1, and on which a suitable elastomer closure is mounted according to ISO 8362-5, so that freeze-drying can be carried out. During freeze-drying, the water is removed directly from the frozen medical substance by sublimation of the ice in a vacuum at a pressure of typically 0.1 to 0.3 mbar. During the freeze-drying process, the elastomer closure rests only lightly on the head part in the neck of the container, so that, on the one hand, draw-off of air and water vapor from the container is made possible, but on the other hand, the intake of contaminants and microorganisms is prevented. Such a freeze-drying closure is described in, e.g., U.S. Pat. No. 5,522,155, where the transmission of water vapor, on the one hand, and the prevention of the intake of contaminants or microorganisms, on the other hand, are ensured by porous materials, such as, e.g., paper filters, polymer films that are made of, e.g., polyolefin, or PTFE-membranes.

After freeze-drying is completed, the containers are then tightly sealed by virtue of the fact that the plugs of the elastomer freeze-drying closures are pressed tightly into the neck parts of the containers. This can be done in that, e.g., the containers, including the supports, are pressed upward against the lower side of the cover by movable bottom plates in the freeze-drying unit, where the elastomer plugs that are just resting on top are then pressed into the neck parts of the container vials to provide a sealed closure. A similar mechanism is described in WO 97/08503, where a cover plate correspondingly drops from above to press the elastomer closures inward.

The sealing of the plug is then additionally supported by the fact that the negative pressure in the freeze-drying unit is raised to ambient pressure after freeze-drying is completed, while the inside of the container remains under negative pressure. Then, the freeze-drying unit is opened, and the container is removed. To close the container securely, e.g., for mailing, and to keep it from leaking, there is a need for yet another closure safety, which usually is provided by aluminum flange caps according to ISO 8362, Part 6.

In EP 0 655 042, aluminum flange caps are eliminated by using a three-piece closure cap that consists of an inside cap, an insert, and an outside cap. The reason for such an embodiment was that, i.e., in this way the significant variations in the dimensions of the container end areas, i.e., especially at the neck, that occur when glass containers are used and that are due especially to the production process of the same could be better compensated for. In this publication, glass is also regarded as the only acceptable material for containers for freeze-drying medical samples.

The containers for freeze-drying and storing medical products that have been have used to date in the prior art are also primarily vials that are made of glass with round cross-sectional surfaces of the container body, which are produced according to the tube-drawing process similar to ampules. Glass containers that are produced in this way, however, have more or less irregular geometries in the head and neck areas from one to another, depending on container size, and can therefore be subject to considerable mass fluctuations of ±10 to ±20%.

For freeze-drying, on the one hand, in most cases the aqueous solution that is in the containers must first be frozen. This can be done ahead of time outside of the freeze-drying apparatus or else right in the freeze-drying chamber. In this case, the heat is dissipated through the walls of the container; this presupposes that the container material has adequate heat conductivity.

In contrast, the efficiency of a freeze-drying process depends on the ratios of the “active surface” to the filling height of the substance that is to be freeze-dried. “Active surface” is defined as the surface of the frozen substance by which ice from the frozen substance can be sublimated off at low pressure. If medical products are immediately freeze-dried according to the batch process in several containers simultaneously in which the freeze-dried product is then also to be stored over an extended period, then this “active surface” corresponds to the cross-sectional surface of the container body. Generally, these containers for freeze-drying are filled, for example, a third to half full, so that the ratio of “active surface” to the filling height of the substance that is to be freeze-dried is relatively small.

The removal of the sublimation heat that is taken away to sublimate the ice over the surface of the frozen substance generally results in a very strong cooling of the frozen product, still considerably below the freezing temperature. This very low temperature counteracts desirable further sublimation of the ice, however, so that during the freeze-drying process, it is necessary to heat the container in the freeze-drying chamber steadily and actively in order to keep the temperature inside a container from being set significantly below the freezing temperature.

Since the freeze-drying chamber is evacuated, however, significant heating, i.e., heat input of the material that is to be freeze-dried, can be done only via the floor surface of the cylindrical glass container that is placed in the freeze-drying chamber.

The glass vials with a round cross-sectional shape that are used in the prior art have disadvantages with respect to homogeneous freeze-drying of the medical substances that are contained in the individual containers. Because of the above-described irregularities in the container masses and cross-sectional geometries that are produced by the production process, the “active surfaces” also have considerable fluctuations in the respective containers that form a batch, such that the ice in the respective containers is sublimated off to varying extents and the associated cooling effect fluctuates from container to container within a freeze-drying batch. Moreover, in the case of such glass vials, the bottoms are not made uniformly flat, but rather have more or less pronounced vaults, such that the vials that form a batch are additionally distinguished from one another by more or less pronounced tolerances in drawing in the bottom. As a result, then the transfer of heat through the bottoms in the individual vials also fluctuates; ultimately these factors together lead to a batch in the respective containers with uneven freeze2 drying.

Owing to the round cross-sectional shape of the individual vials, no heat can be exchanged by heat conduction via the outside walls of the vials; the vials rather abut on a very good heat insulator, namely the evacuated dead zone between the individual cylindrical vials of a batch. This has the result that the area that is available in the freeze-drying chamber is poorly used by the container that is coated with the substance that is to be freeze-dried.

After freeze-drying is completed, and after the individual containers are sealed by the elastomer closures and before the aluminum flange caps are mounted, the negative pressure that is maintained inside the respective containers, as described above, further contributes to the sealing of the container. During the storage time of the medical products, which can be several years, this negative pressure has an adverse effect since, unlike the glass container, the elastomer closures according to ISO 8362-5 are not themselves water vapor-tight. During the storage time, the penetration of water vapor from the air (suction effect through the elastomer closure) undesirably supports the negative pressure in the container, whereby on the one hand, the water vapor that is contained in the atmospheric air can adversely affect the stability of the freeze-dried medical products that are to be stored, but on the other hand, oxygen-sensitive substances can be destroyed by the atmospheric oxygen.

### SUMMARY OF THE INVENTION

The object of the invention is therefore to make available containers for freeze-drying and storing medical products that do not have the above-described drawbacks.

The body of the container according to the invention is to have flat side areas that are able to come into planar contact with the side areas of the adjacent container body in each case. The cross-sectional shape of such a container body can preferably be a triangle, a quadrilateral, or a hexagon. If the cross-sectional shape is a triangle, then at least two of the three sides are to be of the same size. The preferred triangular cross-sectional shape is an isosceles triangle. In the case where the cross-sectional shape is a quadrilateral, at least two sides that are opposite one another are to be made parallel to one another. Such a cross-sectional shape can be a trapezoid, a parallelogram, a rhombus, a rectangle, and especially a square.

### BRIEF DESCRIPTION OF THE DRAWINGS

To illustrate the possible ways of arranging the containers according to the invention, four embodiments are presented in the accompanying drawings.

FIG. 1 shows an arrangement of the cross-sectional areas of container bodies with a triangular design.

FIG. 2 shows an arrangement of the cross-sectional areas of container bodies with a quadrilateral design, especially a rectangular design.

FIG. 3 shows an arrangement of cross-sectional areas of container bodies with a preferred hexagonal design, whereby the hexagon in each case has two sides of the same length that are opposite one another and two sides that are oriented parallel to one another.

FIG. 4 shows an arrangement of the cross-sectional areas of container bodies with the most preferred embodiment of regular hexagons.

### DETAILED DESCRIPTION OF THE PREFERRED EMBODIMENT

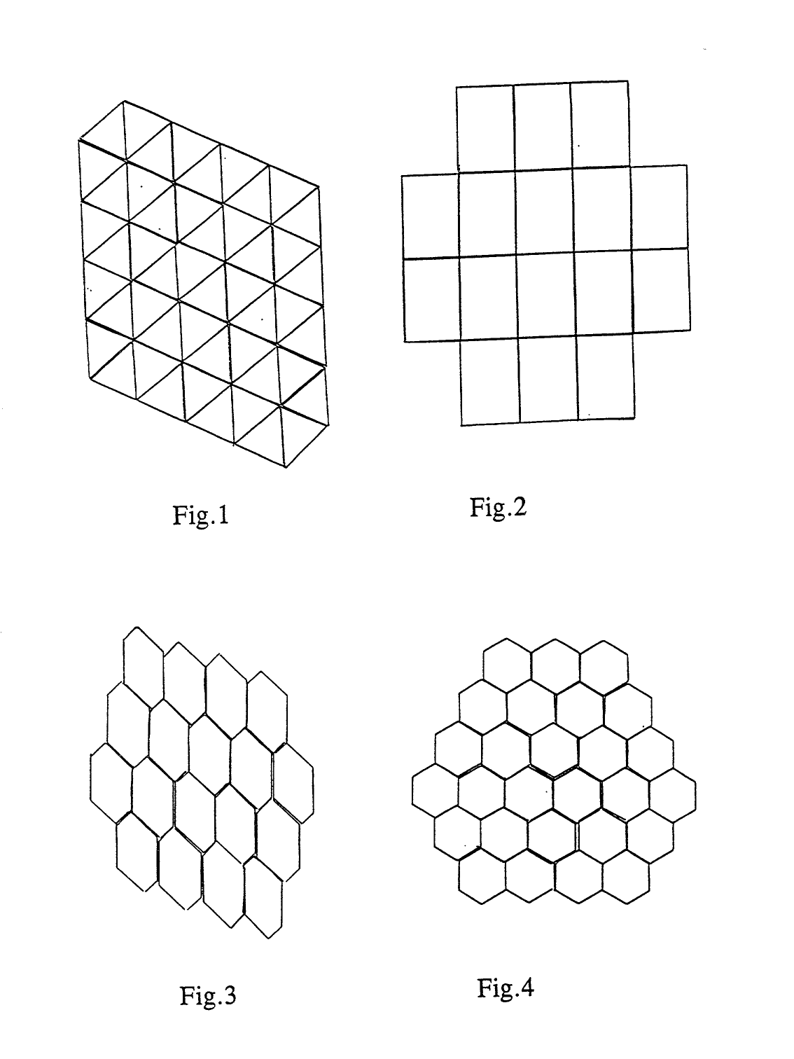

While FIGS. 1 and 2 show squares and rectangles, the preferred cross-sectional shape is that of FIG. 4, i.e., hexagonal, in which case two sides that are opposite one another are of the same length and are parallel to one another. Most preferred is a regular hexagon.

The containers are made of plastic, which is translucent or transparent, so that while it is dissolving just before it is used as directed, the freeze-dried substance can be examined by, e.g., medical personnel. With a wall thickness of 2 mm, the translucent plastic that is used preferably should have a degree of light transmission of >90% according to ASTM 1003. If the plastics that are used are not naturally translucent enough, one skilled in the art can increase transparency by adding additives that are known in the prior art.

The plastic for containers for freeze-drying and storage of sparingly oxygen-sensitive substances is selected from the group with a density of <1.1 g/cm³, a water vapor permeability according to DIN 53122 at a layer thickness of 1 mm of <0.1 g/m^{2.}d, and a water absorption according to ASTM D 570 of <0.05%. Plastic with such specifications can be found especially among the cycloolefin copolymers, such as are commercially available, e.g., under the trade names TOPAS(R) (all types) from the Ticona Company, and ZEONEX® from the Nippon Zeon Company (all types, preferably ZEONEX® 250 and ZEONEX® 280) or APEL® from the Mitsui Company.

Especially preferred are cycloolefin copolymers with a water vapor permeability according to DIN 53122 of <0.03 g/m^{2.}d and a heat resistance temperature (HDTB/B (0.45 N/mm²) according to ISO 75 Parts 1 and 2 in the range between 50° C. and 90° C., such as, for example, TOPAS® 8007 with a glass transition temperature in the range of 60° C. to 100° C.

The plastic for the containers for freeze-drying and storage of strongly oxygen-sensitive substances is selected from the group with a density of ≦1.4 g/cm³ and an oxygen permeability according to DIN 53380 at a layer thickness of 100 μm of <50 cm³/m^{2.}d·bar. Plastic with such specifications is made from, for example, polymers that are based on polyethylene terephthalate (PET), glycol-modified PET (PETG), oriented PET (O-PET), or polyethylene naphthalate (PEN).

The advantages that are provided by the containers according to the invention compared to the round glass vials that are used in the previous prior art are due to both the special shaping of the container body and the selection of the material.

The flat shape of the side areas of the container body, as well as its cross-sectional geometry, makes it possible to arrange a batch of containers that is to be freeze-dried according to the batch process in the freeze-drying chamber in such a way that the available adjustment space can be optimally used. The flat design of the side areas of a container body together with the triangular, quadrilateral, or hexagonal cross-sectional shape make it possible for each container of a batch, if it does not precisely occupy a position on the outside areas of the adjustment area, to be arranged in such a way that it comes to rest with any of its sides in planar contact with the side areas in each case in the container that is adjacent to it. In addition to the optimal use of the adjustment areas, this has the effect that, despite the generally lower heat conductivity of plastics compared to glass, heat transition or equalization can take place between the side areas of the container during the freeze-drying process, such that in all containers of a batch, a more or less homogeneous temperature distribution is achieved. The clearance volumes between the individual containers that unavoidably occur in the case of round glass vials and that act as heat insulators between the walls of the individual containers do not occur in the containers according to the invention. In addition to the homogeneous heat exchange among the individual containers, greater heat exchange than with glass vials can occur between the bottom plate of the freeze-drying unit (cooling plate) and the substance that is to be freeze-dried in the containers since the flat bottom shape with a bottom recess of less than 0.5 mm promotes heat exchange compared to the more or less drawn-in bottoms of containers that are made of glass.

In the case of a specified amount of substance that is to be freeze-dried and a specified adjustment area in a freeze-drying unit, less time is therefore needed when the containers according to the invention are used for freeze-drying than when conventional round vials are used. Since, in the case of specified volumes, the substance that is to be freeze-dried can then be distributed over a larger surface area (relative to the areas for the clearance volumes in the case of round vials), a lower filling height can therefore be set than in the case of round container bodies for the same volume, thereby increasing the ratio of “active surface” to filling height in a container and therefore the efficiency of the sublimation of ice from the active surface. Conversely, when the filling height in the containers according to the invention was the same, a smaller adjustment area was required and thus smaller freeze-drying units than when round glass vials were used.

Unlike for the geometry of the container body, a cylindrical neck and head part is provided in the containers according to the invention as in the containers of the prior art, such that to provide for sealing after the freeze-drying process, standard freeze-drying plugs according to ISO 8362-5 can be used.

The production of the containers is done in a simple way by injection-blow molding, thereby allowing molded elements with very regular wall thicknesses and geometry to be produced. As a result, containers with relatively very tight tolerances in their weight distribution (<±2% compared to ±10% to ±20% in the case of glass vessels) are then obtained; this in turn has the effect that the individual containers have a uniform heat capacity from one to another. The cooling and heating rates of the individual containers from one to another are therefore also the same, so that this results in a homogeneous product quality of a batch that is freeze-dried according to the batch process. Owing to the very tight tolerances in weight distribution, in cases where the uniform filling of the containers by pipetting causes problems, it is also possible to fill the containers according to weight.

In contrast to the glass vials that are used primarily in the prior art, the containers that are made of plastic according to the invention particularly also have another decisive advantage of providing strong protection against breakage because of their lower density (specific mass) which, mainly during the freeze-drying process, reduces the risk of substance losses by breakage and especially the associated risk of a contamination of the freeze-drying unit and all containers that are contained therein.

During shipping and in the case of prolonged storage, however, the plastic also has advantages especially because of its higher impact and shock resistance compared to glass.

The permeability of the plastic that is used according to the invention to gases such as nitrogen and carbon dioxide ensures that the negative pressure that prevails immediately after the end of freeze-drying in the container is advantageously maintained basically only during the critical period after the freeze-drying unit is opened until the final secure closing of the container with the aluminum flange cap. Since the negative pressure then builds up relatively quickly, pressure equalization can be accomplished under controlled conditions, such as, for example, under dry air or, in the case of oxygen-sensitive substances, under a nitrogen atmosphere. Then, during storage, owing to the pressure equalization that prevails between the surrounding area and the inside of the container, virtually no water vapor or oxygen from the surrounding atmosphere penetrates the closure.

Another advantage of the containers according to the invention during freeze-drying is to be observed if, as in the case of the above-cited plastics, the surfaces of the containers according to the invention have pronounced hydrophobicity, such that the adhesion of aqueous products to the walls during the freeze-drying process is small. As a result, homogeneous nucleation of the freezing product is promoted, especially in the case of a container body with the cross-sectional area of a uniform hexagon, which ultimately results in a homogeneous dry product.

Plastic that is based on cycloolefin copolymers has high heat resistance, so that in the case of the temperatures of up to −50° C. that occur in freeze-drying, no embrittlement can occur, so that there is no danger of vulnerability to breakage at these temperatures. TOPAS®8007 from the Ticona Company, e.g., has a glass transition temperature in the range of between 60° C. and 100° C.

The disclosures of each of the patents and publications cited herewithin, as well as the German Priority document 19815993.5-32, are hereby incorporated by reference in their entirety.

1. A container for freeze-drying and storing medical products comprising a body and a cylindrical neck and head part, wherein the container
is made of translucent or transparent plastic,
the body having planar side areas that are adapted to make planar contact with the side areas of a respectively adjacent container body.

2. The container according to claim 1, wherein for freeze-drying and storage of sparingly oxygen-sensitive medical products, the plastic has
a density of <1.1 g/cm³;
a water vapor permeability according to DIN 53122 at a layer thickness of 1 mm of <0.1 g/m² d and
a water adsorption according to ASTM D 570 of <0.05%.

3. Container according to claim 1, wherein for freeze-drying and storage of oxygen-sensitive medical products, the plastic has
a density of ≦1.4 g/cm³ and
an oxygen permeability according to DIN 53380 at a layer thickness of 100 μm of <50 cm³/m^{2.}d bar.

4. Container according to claim 3, wherein the body has a cross-sectional shape of a hexagon with two sides in each case that are opposite to one another, are of the same length, and are oriented parallel to one another.

5. Container according to claim 4, wherein the body has the cross-sectional area of a regular hexagon.

6. Container according to claim 3, wherein the body has the cross-sectional area of a quadrilateral with at least two parallel sides that are opposite to one another.

7. Container according to claim 3, wherein the body has the cross-sectional area of a triangle with at least two sides of the same length.

8. Container according to claim 7, wherein the bottom is flat and has a bottom recess of less than 0.5 mm.

9. Container according to claim 8, wherein the plastic comprises a cycloolefin copolymer.

10. Container according to claim 9, wherein the cycloolefin copolymer is a plastic such as TOPAS®.

11. Container according to claim 10, wherein the cycloolefin copolymer has a water vapor permeability according to DIN 53122 of less than 0.03 g/m² d and a heat resistance temperature (HDTB/B (0.45 N/mm²) according to ISO 75 Parts 1 and 2 in the range of between 50° C. and 90° C.

12. Container according to claim 11, wherein the cycloolefin copolymer has a glass transition temperature in the range of 60° C. to 100° C.

13. Container according to claim 12, wherein the cycloolefin copolymer is TOPAS®8007.

14. Container according to claim 9, wherein the cycloolefin copolymer is of ZEONEX® type.

15. Container according to claim 9, wherein the plastic is of the APEL® type.

16. Container according to claim 3, wherein the plastic comprises polyethylene terephthalate (PET).

17. Container according to claim 3, wherein the plastic comprises PETG.

18. Container according to claim 3, wherein the plastic comprises O-PET.

19. Container according to claim 3, wherein the plastic comprises PEN.

20. Container according to claim 19, wherein the plastic has a light transmission degree according to ASTM 1003 of >90% at a wall thickness of 2 mm.

21. Container according to claim 1, wherein the body has a cross-sectional shape of a hexagon with two sides in each case that are opposite to one another, are of the same length, and are oriented parallel to one another.

22. Container according to claim 1, wherein the body has the cross-sectional area of a quadrilateral with at least two parallel sides that are opposite to one another.

23. Container according to claim 3, wherein the body has the cross-sectional area of a triangle with at least two sides of the same length.

24. Container according to claim 1, wherein the bottom is flat and has a bottom recess of less than 0.5 mm.

25. Container according to claim 9, wherein the plastic comprises a cycloolefin copolymer.

26. Container according to claim 11, wherein the cycloolefin copolymer has a water vapor permeability according to DIN 53122 of less than 0.03 g/m^{2.}d and a heat resistance temperature (HDTB/B (0.45 N/mm²) according to ISO 75 Parts 1 and 2 in the range of between 50° C. and 90° C.

27. Container according to claim 11, wherein the cycloolefin copolymer is TOPAS®8007.

28. Container according to claim 20, wherein the plastic has a light transmission degree according to ASTM 1003 of >90% at a wall thickness of 2 mm.
